(19) United States
(12) Patent Application Publication
(10) Pub. No.: US 2015/0003357 A1
(43) Pub. Date: Jan. 1, 2015

(54) METHOD FOR OUTPUTTING USER-SPECIFIC INFORMATION CONTENTS IN A MEANS OF TRANSPORTATION

(71) Applicant: SIEMENS CONVERGENCE CREATORS GMBH, VIENNA (AT)

(72) Inventor: Gerald Schreiber, Wentorf (DE)

(21) Appl. No.: 14/372,273

(22) PCT Filed: Jan. 9, 2013
(86) PCT No.: PCT/EP2013/050255

§ 371 Date: Jul. 15, 2014

(30) Foreign Application Priority Data
Feb. 7, 2012 (DE) 10 2012 201 786.0

(51) Int. Cl. H04W 76/02; H04W 4/02

(52) U.S. Cl. CPC H04W 76/021; H04W 4/02
USPC 370/329

(57) ABSTRACT

A method for outputting user-specific information contents in a means of transportation, in particular an aircraft is provided. The means of transportation is provided with an information system as well as an access point via which a wireless connection of mobile terminals in the means of transportation, such as mobile telephones, laptop PCs, tablet PCs, etc., to the information system can be established by users of the means of transportation. A mobile terminal, from which a connection to the information system is established, is identified and registered on the information system by means of a unique identification. Then a user-specific booking data record such as a bar code on a ticket, boarding pass etc.—is detected with the mobile terminal, evaluated and transmitted to the information system. Then a link between the user-specific booking data record and the unique identification of the mobile terminal is established by the information system and this link, which can be stored in a database belonging to the information system, is then used to control the output of the user-specific information contents.

### CROSS-REFERENCE TO RELATED APPLICATIONS

This application claims priority to PCT Application No. PCT/EP2013/050255, having a filing date of Jan. 9, 2013, based off DE Application No. 10 2012 201 786.0 having a filing date of Feb. 7, 2012, the entire contents of which are hereby incorporated by reference.

### FIELD OF TECHNOLOGY

The following relates to a method for outputting user-specific information contents in a means of transportation, in particular an aircraft. An information system and an access point to the information system for mobile terminals such as, for example, mobile telephones, laptop PCs, tablet PCs, etc., which the users of the means of transportation bring with them and can be used, for example, as output units for the information contents, are provided in the means of transportation. In this case, a mobile terminal located in the means of transportation can establish a generally wireless connection to the information system via the access point.

### BACKGROUND

Means of transportation for people, such as, aircraft, ships, trains and buses, are nowadays often provided with information systems, from which, for example, data for information purposes and/or for entertainment can be transmitted to output units (for example terminals installed as fixed elements in the means of transportation, mobile user-specific terminals, etc.). In the following, information systems should also be understood to be entertainment systems. Information systems of this kind are used to provide passengers with, for example, information and/or entertainment programs while they are using the respective means of transportation (for example aircraft, ship, train, etc.).

In aircraft, in-flight entertainment systems are used as information systems in order, for example, to transmit information contents (for example audio streams, video streams, flight information, etc.) to the passengers. Systems of this kind have been greatly developed in the last 25 years. Initially, these systems only existed as audio systems via which the passengers were provided with audio information and/or audio data (for example music). From the 1980s, the systems were enhanced to broadcast video information (for example VHS video tapes, which were viewed via group monitors in the aircraft cabin). In the early 1990's, the information systems were enhanced to form in-seat video systems with which a passenger could, for example, select video films or other information, usually on a monitor belonging to the seat by means of an operating mechanism and then view it on the monitor. Since then, information and entertainment systems have, for example, been enhanced for interactive games, audio and/or video-on-demand, real-time flight information, etc., which can be provided to a passenger for purposes of entertainment and/or information. There are also approaches and considerations for offering the passengers entertainment and/or information systems for other means of transportation such as, for example, ships, trains, buses, etc.

In aircraft, information systems usually comprise a central server unit from which, for example, communication takes place with the output units (for example seat monitors, passengers' mobile terminals, etc.), input from passengers is processed and with which the distribution of the information contents is effected. In addition, usually a database belonging to the information system is provided in which, for example, information contents (for example video and/or audio data, etc.) are filed centrally and optionally other data (for example data from output units, etc.) can be stored.

For the distribution of the information contents to the output units and/or for a communication link between the passengers' output units or mobile terminals and the information systems it is possible for an access point to be provided via which the output units can establish a wireless connection to the information system. In this case, it is possible, for example, to use proprietary or standardized radio systems based, for example, on wireless LAN, mobile radio standards (for example Global System for Mobile Communications (GSM), Universal Mobile Telecommunications System (UMTS), Next Generation Mobile Networks (NGMN) or 4G, etc.). Via an access point of this kind in particular passengers with terminals such as, for example, mobile telephones, smartphones, laptops and/or tablet PCs, can establish a connection to the information system within the means of transportation and use information contents. Similar approaches are also conceivable, for example, for passengers on ships or people travelling on trains or buses.

However, at present, information of this kind is provided free of charge on mobile terminals in aircraft which means a user remains anonymous and user-specific adaptation of the information contents is not possible. If information is provided for a charge, the user is usually authenticated during a payment process, although, for reasons of data protection, it is frequently not possible to access the user's authentication data for purposes other than the payment process. However, to offer user-specific information contents, it is necessary to identify a user, in particular the age, gender, optionally a booking class or seat position in the means of transportation, because this, for example, enables the information offered—in particular film or video data—to be adapted user-specifically (for example to the age of the user, etc.) and account to be taken of, for example age ratings for films, etc. In addition, information contents can be compiled and offered to the user according to user-specific preferences (for example according to gender, age, etc.).

In order to be able to offer user-specific information contents via the information system in a means of transportation, in particular an aircraft, it is conceivable, for example, for user-specific data (for example age, gender, seat position in the means of transportation, etc.) to be input manually before the utilization of the information offered, for example, via a control unit and/or the mobile terminal, and made available to the information system. However, this has the drawback that, in the case of manual input, it is possible for erroneous or incorrect data to be entered (for example differentiation between adult and child) and hence it will not be totally authentic. In addition, inputting data of this kind constitutes an additional effort for the user in order to use the information offered in a means of transportation.

### SUMMARY

An aspect relates to a method for outputting user-specific information in a means of transportation which enables the identification of the user and user-specific preparation of the information contents in a simple manner and without additional effort.

The method can be of the type described in the introduction with which a mobile terminal of a user or passenger, via which a wireless connection is established (via the access point) to the information system in the means of transportation, identified by means of a unique identification on the information system and then a user-specific booking data record is detected with the aid of this mobile terminal. The user-specific booking data record is then evaluated and transmitted to the information system. The information system then establishes a link between the user-specific booking data record and the unique identification of the mobile terminal and uses this link to control the output of user-specific information contents.

One aspect of the method includes the fact that in a simple manner and without additional effort, in particular for the user or passenger, a booking data record is made available to the information system which permits authentic identification of the user and hence the user-specific control of information contents in the means of transportation. The entry of the booking data record enables information contents (for example audio data, video data, films, advertisements, etc.) to be prepared and offered optionally adapted with regard to the interests of the respective user, for example, specific to age, specific to gender.

In addition, a link with a unique identification of the mobile terminal used in each case (for example mobile telephone, smartphone, laptop, tablet PC, etc.) also enables better adaptation of resources such as, for example, a bandwidth for the transmission of the information contents to the terminal. In this case, it is also possible, for example, to prioritize resources (for example transmission bandwidth, etc.) according to a booking class and/or a seat position of the user in the means of transportation. In addition, for example by utilizing information on the seat positions of the respective users and hence their mobile terminals in the means of transportation, it is very simple to optimize the use of the wireless connection or the underlying communication system such as, for example, wireless LAN, etc.

The link between the user-specific booking data record and the unique identification of the mobile terminal can be stored in a database belonging to the information system. This enables the information system to be provided with information on the respective user and the corresponding mobile terminals in a simple manner. The information from the user-specific booking data record and on the mobile terminal can then, for example, be used by the information system during the entire usage of the means of transportation in order to compile user-specific information or offer user-specific information to the user. However, the link or the corresponding information can also be used, for example, to adapt resources for data transmission (such as bandwidth, etc.) to, for example, the terminal used or, by utilizing information on spatial positions of mobile terminals in the means of transportation, to optimize frequency utilization of the access point or a service from the wireless connection.

In an exemplary embodiment, an output of the user-specific information contents can be implemented on the mobile terminal and/or a user-specific output unit belonging to the information system. If the mobile terminal is used to output the information contents, it is no longer necessary, for example, to attach additional output means that are fixed to the means of transportation or it is only necessary to attach them in a reduced amount. Alternatively, the user-specific information contents can, for example, be output on an output unit belonging to the information system (for example seat-specific monitor, etc.) in aircraft. For example, the user-specific booking data record provides the information system with details of a seat position or a seat of the user, which enables the information provided at the seat-specific output unit to be adapted specifically to the user—for example according to age, gender, etc.—in a very simple manner.

An exemplary embodiment of the method according to the invention envisages that the evaluation of the user-specific booking data record after detection is performed directly by the mobile terminal. To this end, it is possible, for example, for an application to be provided on the user's mobile terminal by means of which the booking data record is decoded or decrypted and then essential user-specific data (for example age, gender, seat position in the means of transportation, booking class, etc.) are forwarded to the information system. For the link with the unique identification of the mobile terminal, the information system is then only provided with the data required for user-specific adaptation of the information contents and hence the volume of data to be stored in the database is kept to the minimum.

Alternatively, however, it is also conceivable for the evaluation of the user-specific booking data record to be performed after forwarding by the information system. In this case, the booking data record is only detected by the mobile terminal and forwarded to the information system. Decoding or evaluation of the user-specific data contained in the booking data record is only performed by information system. In this procedure no special application for the evaluation of a booking data record has to be provided on the mobile terminal. A user only has to detect the respective booking data record with the mobile terminal The evaluation is then performed centrally by an application provided in the information system in a simple manner that is convenient for the user.

The user-specific booking data record takes the form of an optoelectronically readable code, in particular a bar code, since nowadays, with many means of transportation such as, for example, aircraft or trains, the authorization to use the means of transportation (for example tickets, seat reservations, air tickets, boarding passes, etc.) is now provided with two-dimensional optically legible codes, in particular bar codes. These bar codes are then, for example, available on an authorization to use the means of transportation in both paper form and electronic form and can hence be made accessible for a mobile terminal in a simple manner.

In this case, the user-specific booking data record can, for example, include user-specific data such as in particular name, age, gender, booking class and/or seat position in the means of transportation. For example, in air traffic, the bar-coded boarding pass (BCBP) is used with which a bar code is a component of a boarding pass in both paper form and electronic form and which is standardized internationally by the Air Transport Association (IATA). A BCBP contains, for example, the name of an air passenger, implicitly the gender/age (for example by Mr., Mrs., Chd.), flight number, seat and a booking class in encoded form—i.e. as a bar code—and can hence can be used very simply for the user-specific output of information contents.

In an exemplary embodiment of the method according to the invention, the user-specific booking data record is detected by the mobile terminal with the aid of an optical sensor, in particular a camera. Since nowadays many mobile terminals such as, for example, mobile telephones, smartphones, tablet PCs, have an optical sensor, in particular a digital camera, it is possible to read-in the booking data record—in particular an optically or optoelectronically readable code—for example from an authorization to use the means of transportation in paper form such as, for example, a boarding pass, in a very simple way by means of a mobile terminal.

Alternatively, the user-specific booking data record can be forwarded to the mobile terminal by a booking and/or reservation system. For example, in the case of electronically available authorizations to use a means of transportation (for example an electronic boarding pass for an aircraft, an electronic seat reservation for a train, etc.), which contain an encoded booking data record, the booking data record can be forwarded in a simple manner, for example at the time of booking or on the reservation of the seat or on the online check-in on a mobile terminal (for example mobile telephone, smartphone). The booking data record is then directly available at the mobile terminal and no longer has to be detected by the user for example with the aid of an optical sensor.

Expediently, the unique identification used for the mobile terminal is in particular an IP address, a MAC address and/or a terminal-specific, static or dynamic code. During the establishment of the wireless connection of the mobile terminal to the information system, it is possible, for example, for an IP address to be issued for the data transmission. An IP address is an address of a device or mobile terminal in a communication system based on the Internet Protocol (IP). The IP address is assigned to a device on the establishment of a connection and in this way makes the device addressable and hence accessible. A MAC address is a hardware address, which is used for the unique identification of a device such as a mobile terminal in a communication system.

Alternatively, to the IP or MAC address, the unique identification used for the mobile terminal can be a unique code issued by a manufacturer (for example a serial number, etc.), which is stored, for example, in the terminal in order to identify the mobile terminal on the information system. However, it is also possible to use dynamically generated unique codes as unique identifiers for the identification of the mobile terminal—such as, for example, by means of the use of a code generated by the terminal on the establishment of a connection or a unique code generated by the information system.

With a further embodiment of the method according to the invention, at least one central control output unit is used for monitoring mobile terminals used in the means of transportation. In this case, the at least one control output unit can either be firmly connected to the information system or embodied as a mobile unit from which a wireless connection to the information system is established via the access point. The control output unit is, for example, used to inform a member of staff on of the means of transportation in a simple manner of the seats at which mobile terminals are being used, in order, for example, to refer to the need to switch them off in an aircraft during an approach-to-land. The control output unit can also be used, for example, when selling goods (duty-free goods, drinks, food, etc.), which can, for example, be offered as information content to a user or passenger via the information system to facilitate the delivery of ordered goods.

### BRIEF DESCRIPTION

Some of the embodiments will be described in detail, with reference to the following figures, wherein like designations denote like members, wherein:

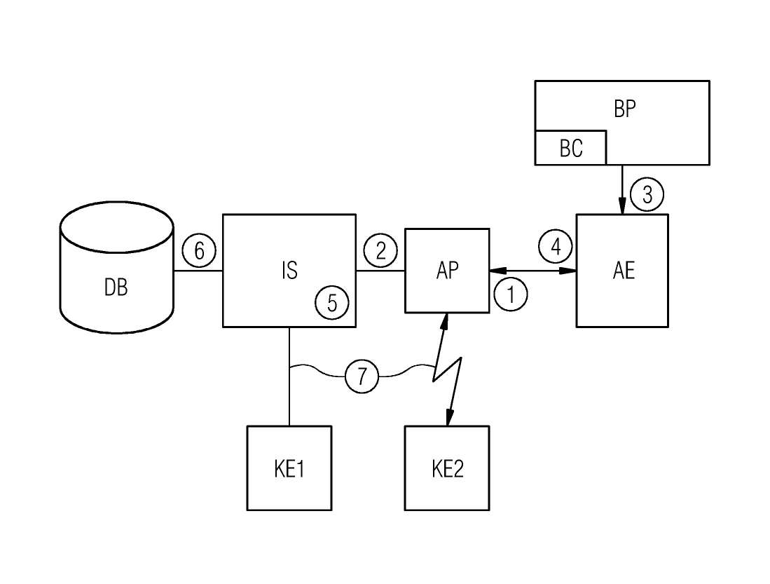

FIG. 1 shows an embodiment of the operation of the method according to the invention when used in an information system in an aircraft.

### DETAILED DESCRIPTION

FIG. 1 is a schematic illustration of an exemplary information system IS, which is fitted in a means of transportation such as, for example, an aircraft. The information system IS can, for example, be an in-flight entertainment system. The information system IS is connected to a database DB belonging to the information system IS in which, for example, information contents, but also user-specific data (for example end terminal identifications, etc.) can be stored. The information system IS also connected to an access point AP via which mobile terminals AE such as, for example, mobile telephones, smartphones, laptops, tablet PCs, etc., located in the means of transportation or in the aircraft can establish a wireless connection to the information system IS in a first step 1.

For the wireless connection between a mobile terminal AE and the access point AP or the information system IS, it is possible, for example, to use radio communication systems such as, for example, wireless LAN, GSM, UMTS or next generation mobile networks or 4G. In this case, the mobile terminal AE is connected wirelessly to the access point AP in the first step 1 and can hence communicate or exchange data with the information system IS. In a second step 2, the mobile terminal AE is then identified on the information system IS by means of a unique identification. For the identification or as a unique identifier, it is possible, for example, to use an IP address, a MAC address or a unique, static code, issued for example by the manufacturer of the mobile terminal AE (for example a serial number). However, it is also conceivable that, for the second step 2, the mobile terminal AE dynamically generates a unique code or a unique identifier—for example by means of an application—for the identification on the information system IS. Alternatively, a dynamic code of this kind can also be generated by the information system IS and, for example, transmitted to the terminal AE and used for a repeat recognition.

In a third step 3, the mobile terminal AE then detects a booking data record BC, which is attached to an authorization to use the means of transportation BP—such as, for example, a bar code BC in the case of a bar-coded boarding pass (BCBP). The booking data record BC can, for example, be detected by an optical sensor such as, for example, a digital camera, which nowadays is usually fitted in many mobile terminals AE or scanned in with the aid of the camera and a special application on the mobile terminal AE. However, the booking data record BC can, for example in the case of an electronic boarding pass BP, be forwarded in advance, for example in the case of a seat reservation, before the flight by a reservation and/or booking system to the mobile terminal AE and it is then available to the mobile terminal before a flight.

In a fourth step 4, the booking data record BC is then evaluated. An evaluation of the booking data record, which, in the case of a bar-coded boarding pass BP, contains, for example, the name, implicitly the age and gender of the user or passenger, flight number, seat and booking class, etc., can be performed either by an application on the mobile terminal AE or by the information system IS. If the booking data record BC is decoded by the mobile terminal AE, after the decoding, the decoded user-specific data is transmitted as data record to the information system IS. If the decoding of the booking data record BC is performed on the information system IS, the encoded booking data record - for example, the bar code detected by the mobile terminal AE for example as an image—is forwarded to the information system IS. The information system IS then converts the booking data record BC into a data record of user-specific data.

In a fifth step 5, a link between the evaluated or decoded booking data record BC—i.e. the data record of user-specific data (for example name, age, gender, seat, etc.) and the unique identification of the mobile terminal AE of the user is established on the information system IS. In a sixth step 6, this link between the decoded booking data record BC and the unique identification of the mobile terminal AE is filed and stored in the database DB belonging to the information system IS. This link can now be used to control the output of information contents (for example audio data, video data, films, advertising, etc.) by the information system IS.

In this way, information contents offered can be adapted age-specifically, gender-specifically, according to the seat position or booking class in the means of transportation or aircraft. It is, for example, possible to take into account age ratings for the films offered or to prepare the information offered in accordance with known gender-specific preferences. In addition, it is also possible to prioritize resources (for example bandwidth, etc.) in accordance with the booking class and/or seat position in the means of transportation or adapt offers for the mobile terminal in question. It is also possible to optimize the frequency utilization of the communication system used for the wireless connection (for example wireless LAN, etc.) by using the information on the seat positions at which information contents are being used via mobile terminals AE. It is also conceivable, on the basis of the knowledge of the user, seat position of the user, etc., for information contents booked and paid prior to take-off or information contents offered as a promotion, for example, to be specially activated for the respective user.

The user-specific information contents can, for example, be output directly at the mobile terminal AE of the respective user. However, it is also conceivable—due to the known seat position of the user—for example in an aircraft, also to use a seat-specific output unit belonging to the information system IS for the output of the user-specific information contents—in particular if, for example, the mobile terminal AE of the user is not totally suitable for an output.

An optional seventh step 7 offers the option of at least one central control output unit KE1, KE2 being used for monitoring mobile terminals AE used in the means of transportation. FIG. 1 shows by way of example two control output units KE1, KE2, wherein a first control output unit KE1 is permanently wired to the information system IS. A second control unit KE2 is connected by a wireless connection via the access point AP to the information system IS. The control output units KE1, KE2 can, for example, be used by the staff on a flight, etc. to obtain knowledge of, for example, names and/or seat positions of passengers using mobile terminals AE during the flight. For example, during an approach-to-land, the passengers can then be reminded to switch off the mobile terminal AE. In addition, the control output units KE1, KE2 can also be used, for example, for a delivery of goods, drinks etc. for onboard sales, since, for example, a passenger making an order can be visualized on the control output unit KE1, KE2.

Moreover, it is also possible to combine the method according to the invention with an operator's booking and/or reservation system (for example airline, etc.) of the means of transportation. This can take place, for example, by means of online access as long as the means of transportation, in particular the aircraft, for example, has a satellite communication system, or offline—i.e. the corresponding data on the booked passengers is transmitted to the information system IS, for example, before the aircraft takes off When combined with a booking and/or reservation system, additional applications for users or passengers would be possible—such as, for example, the continuation of (booked) information contents (for example films, etc.), which could not be viewed to the end because the flight time was too short.

1. A method for outputting user-specific information contents in a means of transportation, in which an information system and an access point for a mobile terminals to the information system are provided, the method comprising:
establishing, by a mobile terminal located in the means of transportation, a wireless connection to the information system via the access point,
identifying the mobile terminal on the information system by means of a unique identification, wherein a user-specific booking data record is detected by the mobile terminal, and the user-specific booking data record is evaluated and transmitted to the information system; and
establishing, by the information system, a link between the user-specific booking data record and the unique identification of the mobile terminal, wherein the link is used to control an output of the user-specific information contents.

2. The method as claimed in claim 1, wherein the link between the user-specific booking data record and the unique identification of the mobile terminal is stored in a database belonging to the information system.

3. The method as claimed claim 1, wherein the user-specific information contents on the mobile terminal and/or a user-specific output unit belonging to the information system are output.

4. A-The method as claimed in claim 1, wherein evaluation of the user-specific booking data record after the detection is performed directly by the mobile terminal.

5. The method as claimed in claim 1, wherein the user-specific booking data record is evaluated following forwarding by the information system.

6. The method as claimed in claim 1, wherein the user-specific booking data record takes the form of an optoelectronically readable code.

7. The method as claimed in claim 1, wherein name, age, gender, booking class and/or seat position in the means of transportation are stored in the user-specific booking data record.

8. The method as claimed in claim 1, wherein the user-specific booking data record is detected by the mobile terminal with the aid of an optical sensor.

9. The method as claimed in claim 1, wherein the user-specific booking data record is forwarded to the mobile terminal from a booking system and/or reservation system.

10. The method as claimed in claim 1, wherein an IP address, a MAC address and/or a terminal-specific, static or dynamic code is used as the unique identification for the mobile terminal.

11. The method as claimed in claim 1, wherein at least one central control output unit is used for monitoring the mobile terminals used in the means of transportation.

12. The method as claimed in claim 11, wherein the at least one control output unit is firmly connected to the information system.

13. The method as claimed in claim 11, wherein the at least one control output unit is a mobile unit from which a wireless connection to the information system is established via the access point.

14. The method as claimed in claim 1, wherein the means of transportation is an aircraft.

15. The method as claimed in claim 5, wherein the optoelectronically readable code is a bar code.

16. The method as claimed in claim 8, wherein the optical sensor is a camera.
